(19) United States
(12) Patent Application Publication
(10) Pub. No.: US 2005/0228631 A1
(43) Pub. Date: Oct. 13, 2005

(54) Model specific register operations

(76) Inventors: John Warren Maly, Laporte, CO (US); Ryan Clarence Thompson, Loveland, CO (US); Zachary Steven Smith, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/819,746

(22) Filed: Apr. 7, 2004

(51) Int. Cl. G06F 9/45

(52) U.S. Cl. 703/22

(57) ABSTRACT

Systems, methodologies, media, and other embodiments associated with manipulating model specific registers are described. One exemplary system embodiment includes a model specific register logic that facilitates manipulating a model specific register so that bits that are irrelevant to a processor simulation are not set for the processor simulation. The exemplary system may also include a data store that is configured to store significance vectors that encode information about (ir)relevant model specific register bits and that facilitate the model specific register logic manipulating a model specific register to a desired initial state.

### BACKGROUND

Designing, testing, and verifying a processor like a microprocessor is a difficult proposition. Processor simulations using processor simulators and/or a variety of tools like register transfer language (RTL) models have become increasingly important to processor design, testing, and verification. In a processor verification environment, a processor simulation initializer may input a set of test vectors and output a set of data and/or instructions that facilitate creating initial conditions for verification tools like a simulator, an RTL model, a checker, and so on.

A test case executed by a processor verification architecture may produce, as part of its output, a set of files that contain coverage information. Coverage information concerns the variety and frequency of certain defined events occurring during a set of processor simulations. Defined events can include, for example, whether an instruction executed, whether an interrupt occurred, whether a processor mode was entered, and so on. Coverage is the primary measure of value in a test case regression.

A processor may include different types of registers. For example, a processor family may include well-known user accessible registers like AX and SI or D0-D7 and A0-A7. However, a processor may also include other, less well-known and less accessible registers. These registers may include a model specific register (MSR) and a processor status register (PSR). MSRs and PSRs may be added, removed, and reconfigured during processor development and may or may not remain in a completed processor design.

A model specific register may be set to facilitate controlling processor behavior and/or modes. Thus, a model specific register can be used to “hack” a processor mode. This can benefit processor development and verification by simplifying configuring a processor into a desired deterministic state for testing. In an environment that includes processor simulation, a processor simulator may simulate MSRs. Thus, the processor simulator may be configured to read initially desired processor state from a simulated MSR. In the simulation environment, MSRs are typically written during simulation configuration and not during a simulation run.

A PSR may include status bits that are set by a processor or processor simulator to report occurrences like processor status transitions, processor events (e.g., errors), processor mode transitions, and so on. In an environment that includes processor simulation, a processor simulator may simulate PSRs. Thus, the processor simulator may be configured to note processor status changes by manipulating bits in a simulated PSR.

A processor may have different functional areas, may be designed in different phases by different people at different times, may go through several revisions, and so on. One area, phase, or revision may rely on certain MSRs during design and verification. Another area, phase, or revision may rely on other MSRs. It is unlikely that a model specific register that is well known to one area, phase or revision may be similarly well known to another area, phase or revision. Thus, the model specific register logic and significance vector data store facilitate building verification tools that capture and memorialize knowledge of MSRs.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. The illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Elements may not be drawn to scale.

FIG. 1 illustrates an example system for manipulating model specific registers.

FIG. 2 illustrates another example system for manipulating model specific registers.

FIG. 3 illustrates an example system for acquiring processor status register bit transition data.

FIG. 4 illustrates another example system for acquiring processor status register bit transition data.

FIG. 5 illustrates an example system for manipulating model specific registers and acquiring processor status register bit transition data.

FIG. 6 illustrates an example system for correlating processor status register bit transition data with model specific register manipulations.

FIG. 7 illustrates an example system for evaluating processor mode coverage.

FIG. 8 illustrates an example method for preventing irrelevant model specific register bits from being set in a processor simulation and acquiring processor status register bit transition data from a processor simulation.

FIG. 9 illustrates an example computing environment in which example systems and methods illustrated herein can operate.

FIG. 10 illustrates an example application programming interface (API).

FIG. 11 illustrates an example method for making choices concerning model specific register manipulations.

### DETAILED DESCRIPTION

Example systems and methods described herein concern using model specific registers and significance vectors to facilitate establishing known valid states for processor simulations. Example systems and methods also concern acquiring processor status register bit transition data generated during processor simulations. Thus, some example systems and methods facilitate evaluating processor mode coverage. Relationships between model status register initializations and processor status register bit transitions can facilitate providing coverage analysis context. For example, targeted test cases can be written to attempt to place a processor simulation into certain modes and then have certain actions occur while those modes are present. Establishing the modes is facilitated by manipulating the model specific registers and observing the actions that occur when the modes are present is facilitated by accessing the processor status registers.

Some model specific register bits cannot be meaningfully set in a verification environment. For example, a certain feature may not be implemented and thus the model specific register bit that controls a mode for that feature is irrelevant. An engineer who sets the model specific register bit in a test case may believe that setting the bit is having some effect in the test case. To prevent the engineer from maintaining the erroneous thought, a model specific register logic may reconfigure model specific registers configured by a processor simulation initializer and report on the reconfiguration. The model specific register logic may access a significance vector to configure the model specific register. In one example, the model specific register logic may perform a logical AND operation between the contents of the model specific register and the significance vector. To avoid “garbage in, garbage out”, the significance vectors may be applied to the model specific registers. Thus, significance vectors facilitate putting verifiably meaningful or relevant zeroes and ones into model specific registers rather than just putting what an engineer may believe are meaningful or relevant zeroes and ones into model specific registers.

The following includes definitions of selected terms employed herein. The definitions may include various examples that fall within the scope of a term. The examples are not intended to be limiting. Both singular and plural forms of terms may be within the definitions.

“Computer component”, as used herein, refers to a computer-related entity like hardware, firmware, software, or a combination thereof. Computer components can include, for example, a process running on a processor, a processor, an object, an executable, a thread of execution, a program, a computer, and so on. Computer components may be localized on one computer and/or distributed between two or more computers.

“Computer-readable medium”, as used herein, refers to a medium that participates in directly or indirectly providing signals, instructions and/or data to a computer component. A computer-readable medium may take forms like non-volatile media (e.g., optical disk, magnetic disk), volatile media (e.g., magnetic disk, dynamic memory), transmission media (e.g., coaxial cables, copper wire, fiber optic cables), and the like. Transmission media may also take the form of electromagnetic radiation, like that generated during radio-wave and infra-red data communications, or take the form of one or more groups of signals. Common forms of a computer-readable medium include, floppy disks, hard disks, magnetic tapes, CD-ROMs, RAMs, ROMs, EPROMs, other memory chips or cards, memory sticks, carrier waves/pulses, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data represented by electrical and/or magnetic signals. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, may include hardware, firmware, software and/or combinations thereof that perform a function(s) or an action(s), and/or that cause a function or action from another logic, method, and/or system. For example, a logic may include a software controlled microprocessor, discrete logic like an application specific integrated circuit (ASIC), a programmed logic device, a memory device containing instructions, and so on. A logic may include one or more gates, combinations of gates, or other circuit components. A logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected” or “operably connectable”, is one in which signals, physical communications, and/or logical communications may be sent and/or received. Typically, an operable connection includes a physical interface, an electrical interface, and/or a data interface, but an operable connection may include differing combinations of these or other types of connections sufficient to allow operable control. For example, two entities can be operably connected by being able to communicate signals to each other directly or through intermediate computer components, logics, and so on. Logical and/or physical communication channels can create an operable connection.

“Signal”, as used herein, includes but is not limited to an electrical, magnetic, or optical signal(s), analog or digital signal(s), data, computer or processor instruction(s), message(s), bit or bit stream, or other means that can be received, transmitted and/or detected by a computer component and/or logic.

“Software”, as used herein, refers to computer or processor instructions that can be read, interpreted, compiled, and/or executed to cause a computer, computer component, processor, or other electronic device to perform an action(s) and/or behave in a desired manner. The instructions may be embodied in various forms like routines, algorithms, modules, methods, threads, and/or programs including separate applications or instructions from dynamically linked libraries. Software may be implemented in a variety of executable and/or loadable forms including, but not limited to, a stand-alone program, a function call (local and/or remote), a servelet, an applet, instructions stored in a memory, part of an operating system or other types of executable instructions. Software can be located in one logic and/or distributed between two or more communicating, co-operating, and/or parallel processing logics and thus can be loaded and/or executed in serial, parallel, massively parallel and other manners.

Suitable software for implementing various components of the example systems and methods include programming languages and tools like Java, Pascal, C#, C++, C, CGI, Perl, SQL, APIs, SDKs, assembly, firmware, microcode, and so on. Software, whether an entire system or a system component, may be embodied as an article of manufacture and maintained or provided as part of a computer-readable medium as defined previously. Software may be transmitted as signals over a network or other communication medium. Thus, in one example, a computer-readable medium takes the form of signals that represent software as it is downloaded from a web server to a user. In another example, the computer-readable medium takes the form of software as it is maintained on the web server.

Some portions of the following detailed description are presented in terms of algorithms and symbolic representations of operations on data bits in a memory. These algorithmic descriptions and symbolic representations are means used by those skilled in the art to convey the substance of their work to others. An algorithm is here, and generally, conceived to be a sequence of operations that produce a tangible, concrete, real-world result. The operations may include physical manipulations of physical items. The physical items may take the form of electrical or magnetic signals capable of being stored, transferred, combined, compared, and otherwise manipulated in a logic, computer memory, and the like.

It has proven convenient at times, principally for reasons of common usage, to refer to these signals as bits, values, elements, symbols, characters, terms, numbers, or the like. These and similar terms are to be associated with appropriate physical items and are merely convenient labels applied to these items. Throughout the description, terms like processing, computing, calculating, determining, displaying, or the like, unless stated otherwise, refer to actions and processes of a computer component, processor, or similar electronic device that manipulates and transforms data represented as physical (electronic) quantities.

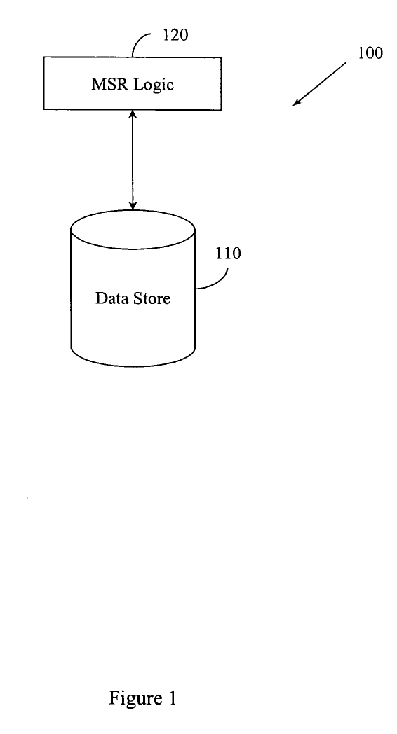

FIG. 1 illustrates an example system 100 for manipulating model specific registers. The system 100 may include a data store 110 that is configured to store a set of significance vectors. A significance vector may encode information concerning which bits in a model specific register that is related to the significance vector are relevant in a processor simulation. For example, a model specific register may have a first bit that controls whether a processor will enter a first mode and a second bit that controls whether the processor will enter a second mode. If at a certain point in time in processor development the first mode has been implemented, then the first bit may be relevant to a simulation run and a significance vector applied to a model specific register would not mask out that bit. However, if at that point in time in processor development the second mode has not been implemented, then the second bit may not be relevant and a significance vector could mask out that bit.

The system 100 may also include a model specific register logic 120 that is operably connected to the data store 110. The model specific register logic 120 may be configured to facilitate initializing a model specific register associated with a processor simulator to an initial value that is relevant to a processor simulation. The model specific register logic 120 may apply a member of the set of significance vectors to achieve the configuration. When and how the significance vector may be applied may depend on the configuration of a verification environment.

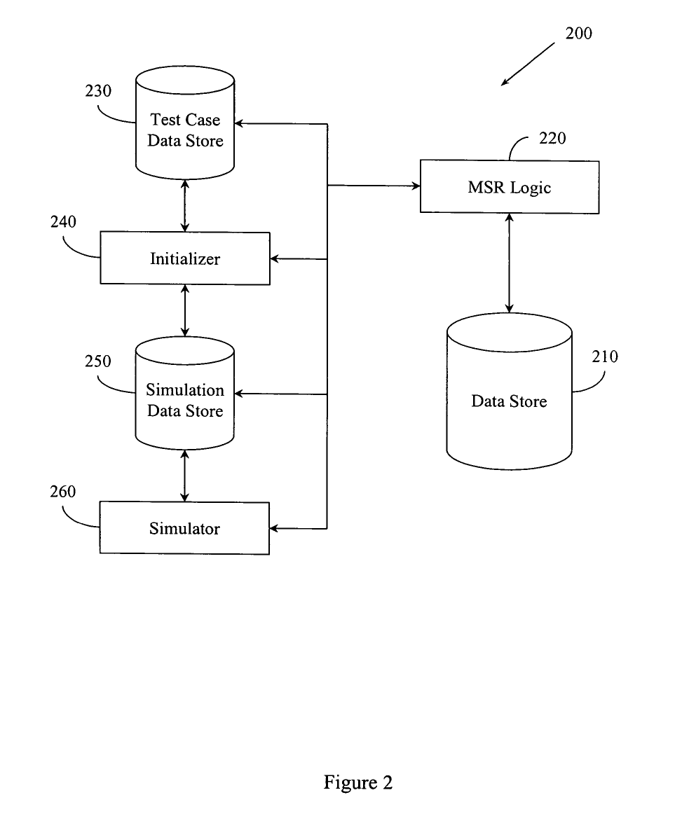

Thus, FIG. 2 illustrates an example system 200 for manipulating model specific registers that illustrates various methods for applying a significance vector. The system 200 may include a data store 210 in which the significance vectors are stored and a model specific register logic 220 configured to apply those significance vectors. The significance vectors may be applied to facilitate configuring a model specific register in a processor simulator to a known valid initial value. In one example, the model specific register logic 220 may be configured to apply a significance vector(s) to a test case data stored in a test case data store 230. The test case data may be available to a processor simulation initializer 240. In another example, the model specific register logic 220 may be configured to apply a significance vector to a simulation data stored in a simulation data store 250. The simulation data may be available to a processor simulator 260 and may include data and/or instructions produced by the processor simulation initializer 240. In yet another example, the model specific register logic 220 may be configured to apply a significance vector to a machine specific register associated with the simulator 260. The machine specific register may have been previously initialized by the processor simulation initializer 240. In this example, where the model specific register logic 220 applies a significance vector to a model specific register in the simulator 260, the model specific register logic 220 may perform a logical AND operation between the contents of the model specific register and the significance vector.

The model specific register logic 220 may also be configured to take various actions based on detecting that a significance vector changed a model specific register content. The actions may be, for example, user configurable and/or pre-determinable. Thus, in one example, the model specific register logic 220 may be configured to prevent a processor simulation initializer 240 from initializing a processor simulator 260. In another example, the model specific register logic 220 may be configured to prevent a processor simulator 260 from running and/or to generate an error message concerning an irrelevant model specific register bit being set. Additionally, the model specific register logic 220 may be further configured to present a user with a choice concerning whether to run a processor simulation when the model specific register logic 220 determines that an irrelevant model specific register bit is set. For example, a warning message may be presented that warns a tester that a model specific register bit was changed and that the test being run may not accurately reflect their thinking concerning initial register and/or processor states.

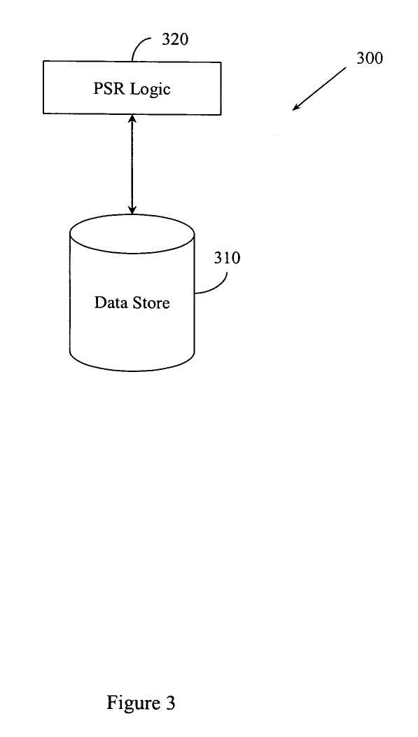

FIG. 3 illustrates an example system 300 for acquiring processor status register bit transition data. The system 300 may include a data store 310 that is configured to store a processor status bit transition data. The processor status bit transition data may encode information concerning processor status bit transitions that occur during a processor simulation. For example, a first processor status bit may be set if a processor switches from a first processor mode to a second processor mode.

The system 300 may also include a processor status register logic 320 that is operably connected to the data store 310. The processor status register logic 320 may be configured to detect a processor status bit transition that occurs during a processor simulation. Similarly, the processor status register logic 320 may be configured to store the processor status bit transition data in the data store 310. In one example, the processor status register logic 320 may be configured to detect processor status bit transitions while a processor simulation is running. In another example, the processor status register logic 320 may be configured to detect processor status bit transitions after a processor simulation has completed.

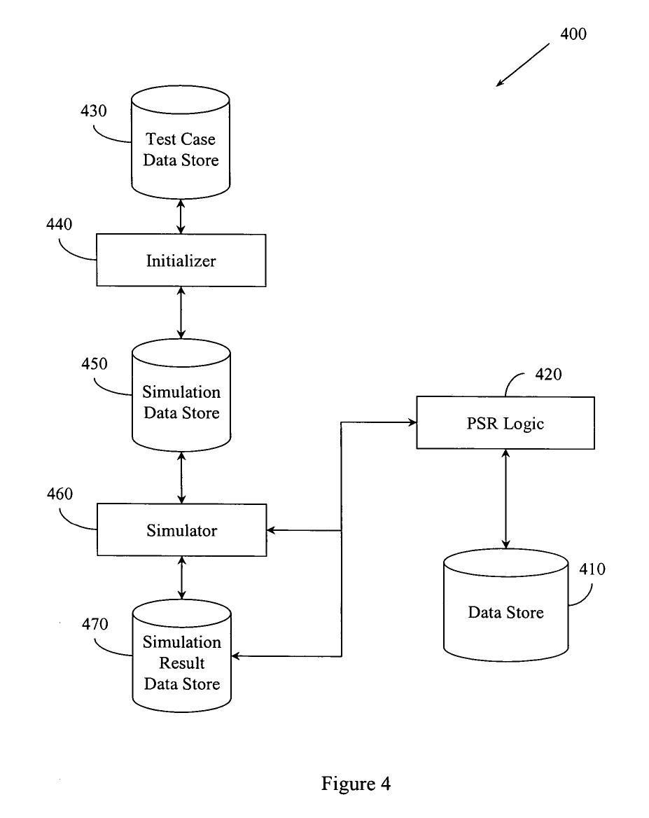

Thus, FIG. 4 illustrates an example system 400 for acquiring processor status register bit transition data. The system 400 may include a data store 410 for storing processor status bit transition data and a processor status register logic configured to detect processor register status bit transitions and to store the processor status register bit transition data. A verification environment with which the system 400 interacts may include a test case data store 430 that stores test case data like test vectors and provides this test case data to a processor simulation initializer 440. The initializer 440 may create a simulation data that can be stored in a simulation data store 450. The simulation data may facilitate producing initial conditions, states, modes, and so on, in a simulator 460. The simulator 460 may run a processor simulation and store coverage information, bit transition information, and the like in a simulation result data that is stored in a simulation result data store 470.

In one example, the PSR logic 420 may be configured to detect processor status register bit transitions while simulator 460 is running a processor simulation. In another example, the processor status register logic 420 may be configured to detect processor status register bit transitions by examining the simulation data stored in the simulation result data store 470. Additionally, and/or alternatively, the processor status register logic 420 may detect some processor status register bit transitions from the simulator 460 and others by examining the simulation result data store 470.

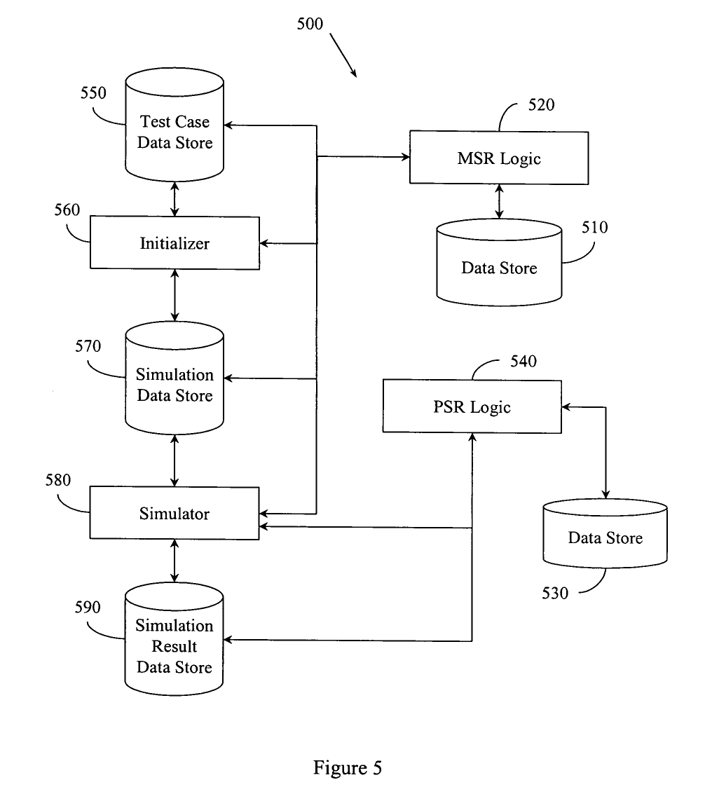

FIG. 5 illustrates an example system 500 for manipulating model specific registers and acquiring processor status register bit transition data. The system 500 combines elements of system 100 (FIG. 1) and system 300 (FIG. 3) and interacts with a verification environment. The verification environment with which system 500 interacts may include a test case data store 550 that stores test case data like test vectors and provides this test case data to a processor simulation initializer 560. The initializer 560 may create a simulation data that can be stored in a simulation data store 570. The simulation data may facilitate producing initial conditions, states, modes, and so on, in a simulator 580. The simulator 580 may run a processor simulation and store coverage information, bit transition information, and the like in a simulation result data that is stored in a simulation result data store 590.

The system 500 may include a first data store 510 that is configured to store a set of significance vectors that encode information concerning which bits in a model specific register related to the significance vector are relevant in a processor simulation. The system 500 may also include a model specific register logic 520 that is operably connected to the first data store 510. The model specific register logic 520 may be configured to facilitate initializing a model specific register associated with the processor simulator 580 to an initial value that is relevant to the processor simulation.

The system 500 may also include a second data store 530 that is configured to store a processor status bit transition data that encodes information concerning processor status bit transitions that occur during the processor simulation run by the simulator 580. The system 500 may also include a processor status register logic 540 that is operably connected to the second data store 530. The processor status register logic 540 may be configured to detect a processor status register bit transition that occurs during a processor simulation run by the simulator 580. After detecting that a processor status register bit transition occurred, the processor status register logic 540 may store processor status bit transition data in the second data store 530.

As described above, a model specific register logic may be configured to apply significance vectors at various points in time to various data and/or registers. Thus, the model specific register logic 520 may be configured to apply a significance vector to a test case data available to the processor simulation initializer 560, to a simulation data available to a processor simulator 580 by the processor simulation initializer 560, to a machine specific register associated with the processor simulator 580, and so on.

In one configuration, the system 500 may take user configurable and/or dynamically updateable actions based on the model specific register logic 520 detecting that applying a significance vector changed a model specific register logic content. Thus, the model specific register logic 520 may be configured to perform actions like, preventing processor simulation initializer 560 from initializing processor simulator 580, preventing processor simulator 580 from running, generating an error message concerning an irrelevant model specific register bit being set, presenting a user with a choice concerning whether to run a processor simulation, and so on.

In one example, the processor status register logic 540 may be configured to detect processor status bit transitions while a processor simulation is running, after a processor simulation has completed, combinations thereof, and so on.

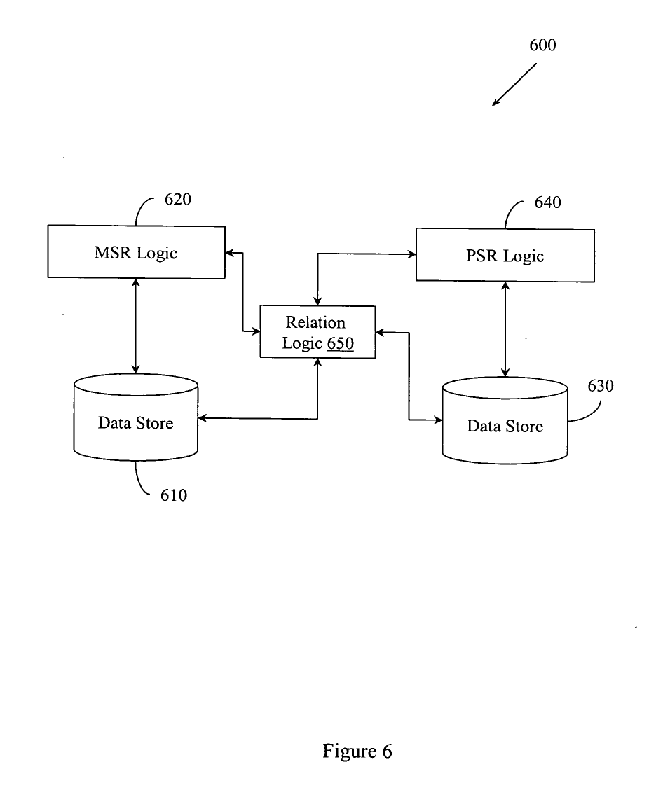

FIG. 6 illustrates an example system for 600 correlating processor status register bit transition data with model specific register manipulations. The system 600 may include a first data store 610 and model specific register logic 620 similar to those described above. Similarly, the system 600 may include a second data store 630 and processor status register logic 640 similar to those described above. Additionally, the system 600 may include a relation logic 650 that is configured to determine a relationship between processor status bit transition data stored in data store 630 and the relevant initial value to which the model specific register logic 620 configured a model specific register based on a significance vector stored in data store 610. The relationship may involve, for example, determining whether processor status register bit transitions occurred and/or differed based on which, if any, significance vectors were applied by the model specific register logic 620. Additionally, and/or alternatively, the relationship may involve, for example, determining whether certain processor modes were covered during a simulation where a certain significance vector was applied by the model specific register 620. While two relationships are described, it is to be appreciated that other relationships may also be examined.

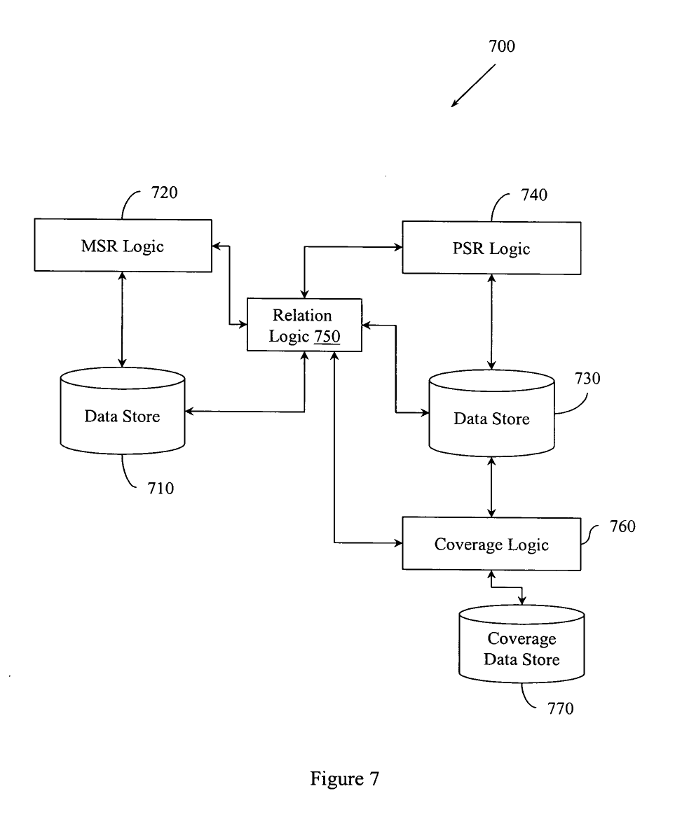

FIG. 7 illustrates an example system 700 for evaluating processor mode coverage. The system 700 may include a first data store 710 and model specific register logic 720 similar to those described above. Similarly, the system 700 may include a second data store 730 and processor status register logic 740 similar to those described above. Likewise, the system 700 may include a relation logic 750 similar to that described above. Additionally, the system 700 may include a coverage logic 760 that is configured to determine whether a desired processor mode coverage was achieved by a processor simulation. In one example, the coverage logic 760 determines whether the desired processor mode coverage was achieved by identifying whether a required number and variety of defined events occurred during the processor simulation. Defined events may include, for example, an instruction being executed, an L1 cache operation occurring, an L2 cache operation occurring, an interrupt occurring, a register transfer language action occurring, a cache flush occurring, and a memory fetch occurring. The coverage logic 760 may store coverage information in a coverage data store 770, which may facilitate, for example, producing formatted reports concerning coverage.

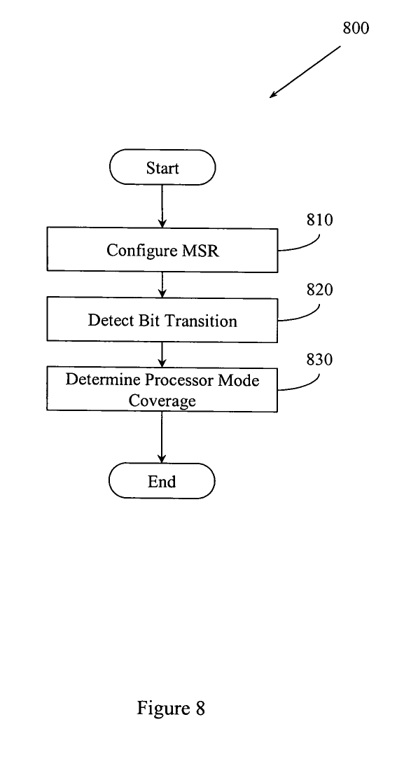

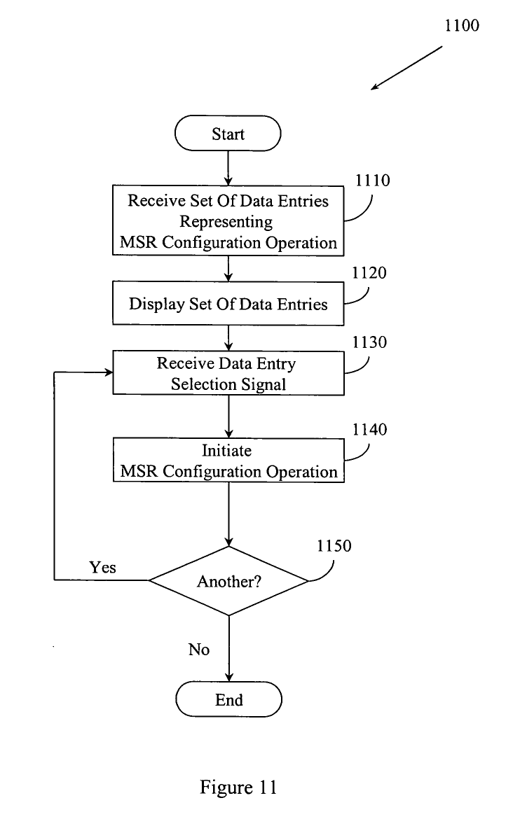

Example methods may be better appreciated with reference to the flow diagrams of FIGS. 8 and 11. While for purposes of simplicity of explanation, the example methodologies are described as a series of actions, it is to be appreciated that the methodologies are not limited by the order of the actions, as some may occur in different orders and/or concurrently with others. Moreover, less than all the illustrated actions may be required to implement an example methodology. Furthermore, additional and/or alternative methodologies can employ additional, not illustrated actions.

In flow diagrams, blocks denote actions that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be appreciated that the actions may be implemented using various programming approaches like machine language, procedural, object oriented and/or artificial intelligence techniques.

FIG. 8 illustrates an example method 800 for preventing irrelevant model specific register bits from being set in a processor simulation and for acquiring processor status register bit transition data from a processor simulation. Acquiring the processor status register bit transition data can facilitate determining processor mode coverage achieved during a simulation.

The method 800 may include, at 810, configuring a model specific register associated with a processor simulator with an initial value that is known to be relevant to a processor simulation. In one example, configuring a model specific register associated with a processor simulator includes performing a logical AND operation of the contents of a model specific register initialized by a processor simulation initializer and a significance vector associated with the model specific register. The initial value for the model specific register may facilitate controlling matters like, whether a core is operational in the processor simulation, whether a set of cores operate in a lock-step mode in the processor simulation, what type of cache coherency protocol is employed in the processor simulation, whether a protected memory model is employed in the processor simulation, and the like.

The method 800 may also include, at 820, detecting a bit transition that occurs in a processor status register during the processor simulation. The bit transition may be detected at times like, while a processor simulation runs, after the processor simulation runs, and so on.

The method 800 may also include, at 830, determining whether a desired processor mode coverage was achieved by a processor simulation. In one example, determining whether the desired coverage was achieved may include analyzing a relationship between the detected bit transition in the processor status register and the initial value to which the model specific register was configured. In another example, determining whether a desired processor mode coverage was achieved includes identifying the type and number of defined events that occurred during the processor simulation. The occurrence of a defined event may be identified by analyzing a bit transition in a processor status register. Defined events may include, for example, an instruction being executed, an L1 cache operation occurring, an L2 cache operation occurring, an interrupt occurring, a register transfer language action occurring, a cache flush occurring, a memory fetch occurring, and so on.

While FIG. 8 illustrates various actions occurring in serial, it is to be appreciated that various actions illustrated in FIG. 8 could occur substantially in parallel. By way of illustration, a first process could configure a model specific register to an initial value that is known to be relevant to a processor simulation, a second process could detect bit transitions that occur in a processor status register during the processor simulation, and a third process could determine whether a desired processor mode coverage was achieved by the processor simulation. While three processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method that includes configuring a model specific register associated with a processor simulation with an initial value that is known to be relevant to the processor simulation. The initial value may facilitate controlling, for example, whether a core is operational in the processor simulation, whether a set of cores operate in a lock-step mode in the processor simulation, what type of cache coherency protocol is employed in the processor simulation, and whether a protected memory model is employed in the processor simulation. The method may also include, for example, detecting a bit transition that occurs in a processor status register during the processor simulation and determining whether a desired processor mode coverage was achieved by the processor simulation by analyzing a relationship between the detected bit transition in the processor status register, the initial value to which the model specific register was configured and the type and number of defined events that occurred during the processor simulation. The occurrence of a defined event may be identified, for example, by analyzing a bit transition in a processor status register. A defined event may include, for example, an instruction being executed, an L1 cache operation occurring, an L2 cache operation occurring, an interrupt occurring, a register transfer language action occurring, a cache flush occurring, and a memory fetch occurring.

While the above method is described being stored on a computer-readable medium, it is to be appreciated that other example methods described herein can also be stored on a computer-readable medium.

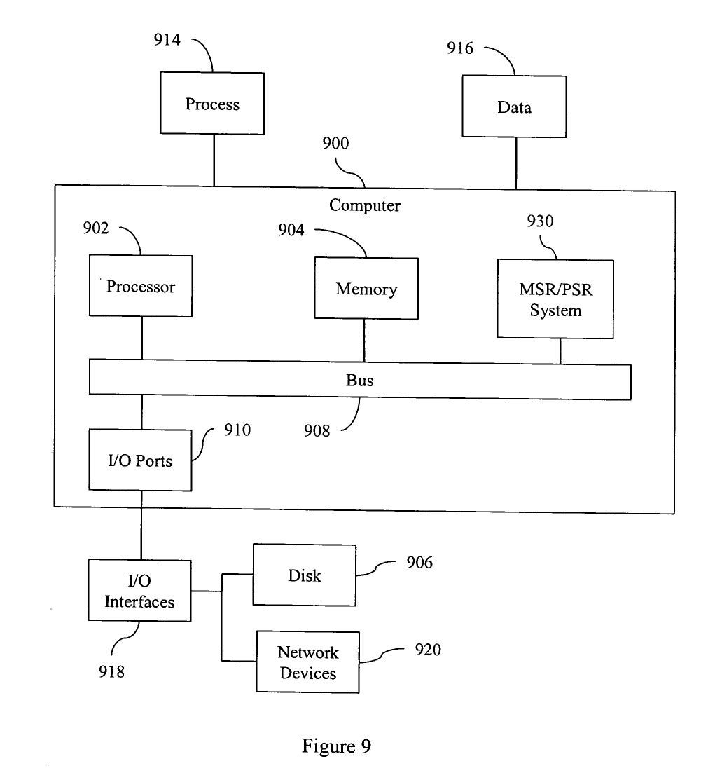

FIG. 9 illustrates a computer 900 that includes a processor 902, a memory 904, and input/output ports 910 operably connected by a bus 908. In one example, the computer 900 may include an MSR/PSR system 930 configured to facilitate evaluating processor mode coverage in a processor simulation. Whether implemented as hardware, firmware, software, and/or combinations thereof, the MSRIPSR system 930 may provide means for establishing a desired state in a model specific register to be accessed by a processor simulator, means for detecting a bit state transition in a processor status register that is writeable by the processor simulator, and means for determining whether a desired processor mode coverage was achieved by the processor simulator by comparing the detected bit state transition to the desired state in the model specific register.

The processor 902 can be a variety of processors including dual microprocessor and other multi-processor architectures. The memory 904 can include volatile memory (e.g., RAM, synchronous RAM (SRAM), dynamic RAM (DRAM), synchronous DRAM (SDRAM), double data rate SDRAM (DDR SDRAM), direct RAM bus RAM (DRRAM)), non-volatile memory (e.g., ROM, PROM, EPROM, EEPROM), and the like.

A disk 906 may be operably connected to the computer 900 via, for example, an input/output interface (e.g., card, device) 918 and an input/output port 910. The disk 906 may take forms like a magnetic disk drive, a solid state disk drive, a floppy disk drive, a tape drive, a Zip drive, a flash memory card, a memory stick, and the like. Furthermore, disk 906 may take forms like optical drives like a CD-ROM, a CD recordable drive (CD-R drive), a CD rewriteable drive (CD-RW drive), and/or a digital video ROM drive (DVD ROM). The memory 904 can store processes 914 and/or data 916, for example. The disk 906 and/or memory 904 may store an operating system configured to control and allocate resources of the computer 900.

The bus 908 can be a single internal bus interconnect architecture and/or other bus or mesh architectures. While a single bus is illustrated, it is to be appreciated that computer 900 may communicate with various devices, logics, and peripherals using other busses that are not illustrated (e.g., PCIE, SATA, Infiniband, 1394, USB, Ethernet). The bus 908 can take forms like a memory bus or memory controller, a peripheral bus or external bus, a crossbar switch, a local bus, and so on. The local bus can take forms like an industrial standard architecture (ISA) bus, a microchannel architecture (MSA) bus, an extended ISA (EISA) bus, a peripheral component interconnect (PCI) bus, a universal serial (USB) bus, a small computer systems interface (SCSI) bus, and so on.

The computer 900 may interact with input/output devices via i/o interfaces 918 and input/output ports 910. Input/output devices may include, for example, a keyboard, a microphone, a pointing and selection device, cameras, video cards, displays, disk 906, network devices 920, and the like. The input/output ports 910 may include, for example, serial ports, parallel ports, USB ports, and so on.

The computer 900 can operate in a network environment and thus may be connected to network devices 920 via the i/o devices 918, and/or the i/o ports 910. Through the network devices 920, the computer 900 may interact with a network. Through the network, the computer 900 may be logically connected to remote computers. Networks that the computer 900 may interact with may include, for example, a local area network (LAN), a wide area network (WAN), and so on. The network devices 920 can connect to LAN technologies like fiber distributed data interface (FDDI), copper distributed data interface (CDDI), Ethernet (IEEE 902.3), token ring (IEEE 902.5), wireless computer communication (IEEE 902.11), Bluetooth (IEEE 902.15.1), Zigbee (IEEE 802.15.4) and the like. Similarly, the network devices 920 can connect to WAN technologies like point to point links, circuit switching networks like integrated services digital networks (ISDN), packet switching networks, digital subscriber lines (DSL), and so on.

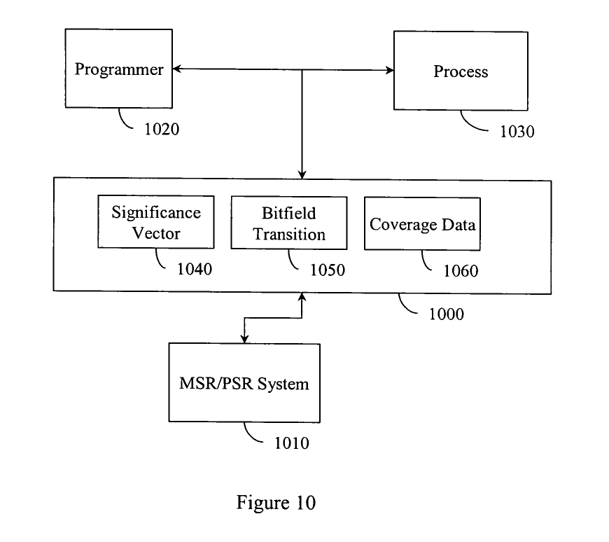

Referring now to FIG. 10, an application programming interface (API) 1000 is illustrated providing access to an MSR/PSR system 1010. The API 1000 can be employed, for example, by a programmer 1020 and/or a process 1030 to gain access to processing performed by the MSR/PSR system 1010. For example, a programmer 1020 can write a program to access the MSR/PSR system 1010 (e.g., invoke its operation, monitor its operation, control its operation) where writing the program is facilitated by the presence of the API 1000. Rather than programmer 1020 having to understand the internals of the MSR/PSR system 1010, the programmer 1020 merely has to learn the interface to the MSR/PSR system 1010. This facilitates encapsulating the functionality of the MSR/PSR system 1010 while exposing that functionality. Similarly, the API 1000 can be employed to provide data values to the MSR/PSR system 1010 and/or retrieve data values from the MSR/PSR system 1010. For example, a process 1030 may provide significance vectors to the MSR/PSR system 1010 via the API 1000 by using a call provided in the API 1000.

Thus, in one example of the API 1000, a set of application programming interfaces can be stored on a computer-readable medium. The interfaces can be employed by a programmer 1020, computer component, logic, process 1030, and so on, to gain access to an MSR/PSR system 1010. The interfaces can include, but are not limited to, a first interface 1040 that communicates a model specific register significance vector, a second interface 1050 that communicates a PSR bit field transition data, and a third interface 1060 that communicates a coverage data derived from the model specific register significance vector and the processor status register bitfield transition as interpreted in light of a processor simulation run.

FIG. 11 illustrates an example method 1100 for making choices concerning model specific register manipulations. The method 1100 may be employed, for example, in a computer system that includes a graphical user interface device. The method 1100 may support a method of providing and selecting from a set of data entries on the display. The method 1100 may include, at 1110, retrieving a set of data entries. A data entry may represent, for example, a model specific register configuration operation. Method 1100 may also include, at 1120, displaying the set of data entries on the display and, at 1130, receiving a data entry selection signal indicative of the selection device selecting a selected data entry. Upon receiving a data entry selection signal, the method 1100 may proceed, at 1140, to initiate a model specific register configuration operation associated with the selected data entry. At 1150 a determination may be made concerning whether to process another data entry selection signal. If the determination is Yes, then processing may return to 1130, otherwise processing may conclude.

While example systems, methods, and so on, have been illustrated and described in considerable detail by describing examples, the examples are not intended to restrict or limit the scope of the appended claims. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. This application is intended to embrace alterations, modifications, and variations that fall within the scope of the appended claims and thus the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. See, Bryan A. Garner, A Dictionary of Modern Legal Usage 624 (2d. Ed. 1995).

1. A system, comprising:
a data store configured to store a set of significance vectors, where a significance vector encodes information concerning which bits in a model specific register related to the significance vector are relevant in a processor simulation; and
a model specific register logic operably connected to the data store, the model specific register logic being configured to facilitate initializing a model specific register associated with the processor simulation to an initial value that is relevant to the processor simulation by applying a member of the set of significance vectors.

2. The system of claim 1, the model specific register logic being configured to apply the member of the set of significance vectors to a test case data available to a processor simulation initializer.

3. The system of claim 1, the model specific register logic being configured to apply the member of the set of significance vectors to a simulation data made available to a processor simulator by a processor simulation initializer.

4. The system of claim 1, the model specific register logic being configured to apply the member of the set of significance vectors to a machine specific register previously initialized by a processor simulation initializer.

5. The system of claim 1, the model specific register logic being further configured to prevent a processor simulation initializer from initializing a processor simulation.

6. The system of claim 1, the model specific register logic being further configured to prevent a processor simulation from running.

7. The system of claim 1, the model specific register logic being further configured to generate an error message concerning an irrelevant model specific register bit being set.

8. The system of claim 1, the model specific register logic being further configured to present a user with a choice concerning whether to run a processor simulation when the model specific register logic determines that an irrelevant model specific register bit is set.

9. A system, comprising:
a data store configured to store a processor status bit transition data that encodes information concerning processor status bit transitions that occur during a processor simulation; and
a processor status register logic operably connected to the data store, the processor status register logic being configured to detect a processor status bit transition that occurs during the processor simulation and to store the processor status bit transition data in the data store.

10. The system of claim 9, the processor status register logic being configured to detect a processor status bit transition while a processor simulation is running.

11. The system of claim 9, the processor status register logic being configured to detect a processor status bit transition after a processor simulation has completed.

12. A system, comprising:
a first data store configured to store a set of significance vectors, where a significance vector encodes information concerning which bits in a model specific register related to the significance vector are relevant in a processor simulation;
a model specific register logic operably connected to the first data store, the model specific register logic being configured to facilitate initializing a model specific register associated with the processor simulation to an initial value that is relevant to the processor simulation by applying a member of the set of significance vectors;
a second data store configured to store a processor status bit transition data that encodes information concerning processor status bit transitions that occur during the processor simulation; and
a processor status register logic operably connected to the second data store, the processor status register logic being configured to detect a processor status bit transition that occurs during the processor simulation and to store the processor status bit transition data in the second data store.

13. The system of claim 12, the model specific register logic being configured to apply the member of the set of significance vectors to one or more of, a test case data available to a processor simulation initializer, a simulation data made available to a processor simulation by a processor simulation initializer, and a machine specific register associated with the processor simulation.

14. The system of claim 12, the model specific register logic being further configured to perform one or more of, preventing a processor simulation initializer from initializing a processor simulator, preventing a processor simulation from running, generating an error message concerning an irrelevant model specific register bit being set, and presenting a user with a choice concerning whether to run a processor simulation when the model specific register logic determines that an irrelevant model specific register bit is set.

15. The system of claim 12, the processor status register logic being configured to detect processor status bit transitions while a processor simulation is running.

16. The system of claim 12, the processor status register logic being configured to detect processor status bit transitions after a processor simulation has completed.

17. The system of claim 12, comprising:
a relation logic configured to determine a relationship between the processor status bit transition data and the relevant initial value to which the model specific register logic configured the model specific register.

18. The system of claim 12, comprising:
a coverage logic configured to determine whether a desired processor mode coverage was achieved by the processor simulation.

19. The system of claim 18, the coverage logic being configured to determine whether the desired processor mode coverage was achieved by the processor simulation by identifying whether one or more of, a required number of defined events occurred during the processor simulation, a required type of defined event occurred during the processor simulation, and a required variety of defined events occurred during the processor simulation.

20. A method, comprising:
configuring a model specific register associated with a processor simulator with an initial value that is known to be relevant to a processor simulation run by the processor simulator;
detecting a bit transition that occurs in a processor status register during the processor simulation; and
determining whether a desired processor mode coverage was achieved by the processor simulation by analyzing a relationship between the detected bit transition in the processor status register and the initial value to which the model specific register was configured.

21. The method of claim 20, where configuring a model specific register associated with a processor simulator includes performing a logical AND operation of the contents of a model specific register initialized by a processor simulation initializer and a significance vector associated with the model specific register.

22. The method of claim 21, where the bit transition is detected while the processor simulation runs.

23. The method of claim 21, where the bit transition is detected after the processor simulation runs.

24. The method of claim 20, where determining whether a desired processor mode coverage was achieved by the processor simulation includes identifying the type and number of defined events that occurred during the processor simulation, where the occurrence of a defined event can be identified by analyzing a bit transition in a processor status register.

25. The method of claim 24, where a defined event includes one or more of, an instruction being executed, an L1 cache operation occurring, an L2 cache operation occurring, an interrupt occurring, a register transfer language action occurring, a cache flush occurring, and a memory fetch occurring.

26. The method of claim 20, where the initial value for the model specific register facilitates controlling one or more of, whether a core is operational in the processor simulation, whether a set of cores operate in a lock-step mode in the processor simulation, what type of cache coherency protocol is employed in the processor simulation, and whether a protected memory model is employed in the processor simulation.

27. A computer-readable medium storing processor executable instructions operable to perform a method, the method comprising:
configuring a model specific register associated with a processor simulation with an initial value that is known to be relevant to the processor simulation, where the initial value facilitates controlling one or more of, whether a core is operational in the processor simulation, whether a set of cores operate in a lock-step mode in the processor simulation, what type of cache coherency protocol is employed in the processor simulation, and whether a protected memory model is employed in the processor simulation;
detecting a bit transition that occurs in a processor status register during the processor simulation; and
determining whether a desired processor mode coverage was achieved by the processor simulation by analyzing a relationship between the detected bit transition in the processor status register, the initial value to which the model specific register was configured and the type and number of defined events that occurred during the processor simulation, where the occurrence of a defined event can be identified by analyzing a bit transition in a processor status register, and where a defined event includes one or more of, an instruction being executed, an L1 cache operation occurring, an L2 cache operation occurring, an interrupt occurring, a register transfer language action occurring, a cache flush occurring, and a memory fetch occurring.

28. A system, comprising:
means for establishing a desired state in a model specific register to be accessed by a processor simulator;
means for detecting a bit state transition in a processor status register that is writeable by the processor simulator; and
means for determining whether a desired processor mode coverage was achieved by the processor simulator by comparing the detected bit state transition to the desired state in the model specific register.

29. A set of application programming interfaces embodied on a computer-readable medium for execution by a computer component in conjunction with evaluating processor mode coverage achieved by a processor simulator, comprising:
a first interface for communicating a model specific register significance vector;
a second interface for communicating a processor status register bitfield transition as interpreted in relation to a processor simulation run; and
a third interface for communicating a coverage data derived from the model specific register significance vector and the processor status register bitfield transition.

30. In a computer system having a graphical user interface comprising a display and a selection device, a method of providing and selecting from a set of data entries on the display, the method comprising:
retrieving a set of data entries, where a data entry represents a model specific register configuration operation;
displaying the set of data entries on the display;
receiving a data entry selection signal indicative of the selection device selecting a selected data entry; and
in response to the data entry selection signal, initiating a model specific register configuration operation associated with the selected data entry.
